(19) United States
(12) Patent Application Publication
(10) Pub. No.: US 2016/0153777 A1
(43) Pub. Date: Jun. 2, 2016

(54) MOVEMENT-TRACE SENSING SYSTEM AND MOTION MODEL CONSTRUCTING METHOD BY USING THE SAME

(71) Applicants: INVENTEC (PUDONG) TECHNOLOGY CORPORATION, SHANGHAI (CN); INVENTEC CORPORATION, TAIPEI CITY (TW)

(72) Inventors: CHUNG-SHENG NI, TAIPEI CITY (TW); CHIH-PIN WEI, TAIPEI (TW); CHUN-YING YANG, TAIPEI CITY (TW)

(21) Appl. No.: 14/684,461

(22) Filed: Apr. 13, 2015

(30) Foreign Application Priority Data
Nov. 28, 2014 (CN) 201410712490.8

(51) Int. Cl. G01B 21/00

(52) U.S. Cl. CPC G01B 21/00

(57) ABSTRACT

A movement-trace sensing system is disclosed which is applied on an object under detection with a plurality of sensing points. The sensing system comprises a plurality of sensors and a host. The sensors are used to respectively sense the movement of the sensing points to generate a plurality of corresponding multi-dimensional coordinate values. The host comprises a sensing unit, a mensuration database, a selecting unit, a pattern constructing unit, a calculating unit, and a dynamic-pattern database. The calculating unit derives movement traces of the sensing points under at least one of dynamic-movement modes according to a specific second static pattern dedicated to the object under detection and multi-dimensional messages corresponding to the sensing points, and further generates a specific mobile pattern corresponding to the object.

### BACKGROUND THE INVENTION

1. Field Invention

The present invention relates to a movement-trace sensing system and a motion model constructing method by using the same, and more particularly, to a movement-trace sensing system and a motion model constructing method to sense an object with a plurality of sensing points.

2. Description of Prior Art

Presently, the mobile situation of an object (people, animal and etc . . . ) is recorded by photos, then the photos are analyzed by image analyzing software, and a movement-trace of the object is derived. However, physical parameters such as force and acceleration which are represented by the movement-trace are unable to be derived.

Moreover, it is impossible to compare the movement-trace of the object and a standard movement-trace. For example, although you know that the posture of an Olympic athlete is better, while you hope to correct your free-style posture (swimming), but the differences of forces and acceleration between you and the Olympic athlete are unable to be displayed; in other words, you cannot correct your posture any further.

### SUMMARY OF THE INVENTION

An objective of the present invention is to provide a movement-trace sensing system which is applied on an object under detection with a plurality of sensing points in order to solve the technical problems of the prior art.

To achieve the above objective, the present invention provides a movement-trace sensing system, which comprises a plurality of sensors and a host. The host comprises a sensing unit, a mensuration database, a selecting unit, a pattern constructing unit, a calculating unit, and a dynamic-pattern database.

A plurality of sensors are used to respectively sense the movement of the sensing points to generate a plurality of corresponding multi-dimensional coordinate values. The sensing unit is used to respectively receive the plurality of corresponding multi-dimensional coordinate values transmitted from the plurality of sensors to generate a plurality of corresponding multi-dimensional coordinate messages. The selecting unit is used to select a first static pattern from the mensuration database based on the object. The pattern constructing unit is used to modify the first static pattern based on the multi-dimensional coordinate messages to build a specific second static pattern dedicated to the object. The dynamic-pattern database is used to store at least one reference sport pattern, the at least one reference sport pattern is used to define at least one sensing node which is under movement. The calculating unit derives movement traces of the sensing points under at least one of referent dynamic-movement modes according to the specific second static pattern dedicated to the object and the multi-dimensional messages corresponding to the sensing points, and further generates a specific mobile pattern corresponding to the object.

In one preferred embodiment, the calculating unit further calculates the corresponding weights of the sensing points by the specific second static pattern dedicated to the object.

In one preferred embodiment, the calculating unit calculates speeds, acceleration, and forces of the sensing points under the at least one of the referent dynamic-movement modes based on the movement traces of the sensing points and the corresponding weights of the sensing points.

In one preferred embodiment, the host further comprises a comparing unit, which compares the specific mobile pattern corresponding to the object and a specific mobile pattern of a preset object.

In one preferred embodiment, the host further comprises a display unit, which displays the specific mobile pattern corresponding to the object and a specific mobile pattern of a preset object.

To solve the above problem, the present invention provides a mobile pattern constructing method for a movement-trace sensing system, which comprises a plurality of sensors and a host.

To achieve the above purpose, the mobile pattern constructing method comprises:

First, sensing the movement of the sensing points to generate and transmit a plurality of corresponding multi-dimensional coordinate values by a plurality of sensors; then, receiving, respectively the plurality of corresponding multi-dimensional coordinate values transmitted from the sensors to generate a plurality of corresponding multi-dimensional coordinate messages by a sensing unit; then, selecting a first static pattern from a mensuration database based on the object by a selecting unit; then modifying the first static pattern based on the multi-dimensional coordinate messages to build a specific second static pattern dedicated to the object by a pattern constructing unit; then, storing at least one reference sport pattern by a dynamic-pattern database, the at least one reference sport pattern is used to define at least one sensing node which is under movement; then, deriving movement traces of the sensing points under at least one of referent dynamic-movement modes according to the specific second static pattern dedicated to the object and the multi-dimensional messages corresponding to the sensing points the calculating unit by a calculating unit; finally, constructing a specific mobile pattern corresponding to the object.

In one preferred embodiment, speeds, acceleration, and forces of the sensing points are calculated under the at least one of referent dynamic-movement modes based on the movement traces of the sensing points and the corresponding weights of the sensing points by the calculating unit.

In one preferred embodiment, the specific mobile pattern corresponding to the object and a specific mobile pattern of a preset object are compared by a comparing unit.

In one preferred embodiment, the specific mobile pattern corresponding to the object and a specific mobile pattern of a preset object are displayed by a displaying unit.

In the present invention, movement-traces of the sensing points tinder at least one of referent dynamic-movement modes are derived according to the specific second static pattern dedicated to the object and the multi-dimensional messages corresponding to the sensing points, and a specific mobile pattern corresponding to the object is further generated. This derives the corresponding physical parameters (speeds, acceleration, forces, etc.) of the plurality of sensing points. In the present invention, by comparing the specific mobile pattern corresponding to the object and the specific mobile pattern of the preset object, the difference between the two objects is clearly determined. For example, while one object is a normal person and the other object is a professional athlete, the normal person could correct his own posture to achieve a better exercise performance according to the difference of the specific mobile patterns of the two objects.

### BRIEF DESCRIPTION OF THE DRAWINGS

FIG. 1 is a block diagram of a movement-trace sensing system of a preferred embodiment of the present invention.

FIG. 2 is a flow diagram of a mobile pattern constructing method for a movement-trace sensing system of a preferred embodiment of the present invention.

### DETAILED DESCRIPTION OF THE PREFERRED EMBODIMENTS

The following description of each embodiment, with reference to the accompanying drawings, is used to exemplify specific embodiments which may be carried out in the present invention.

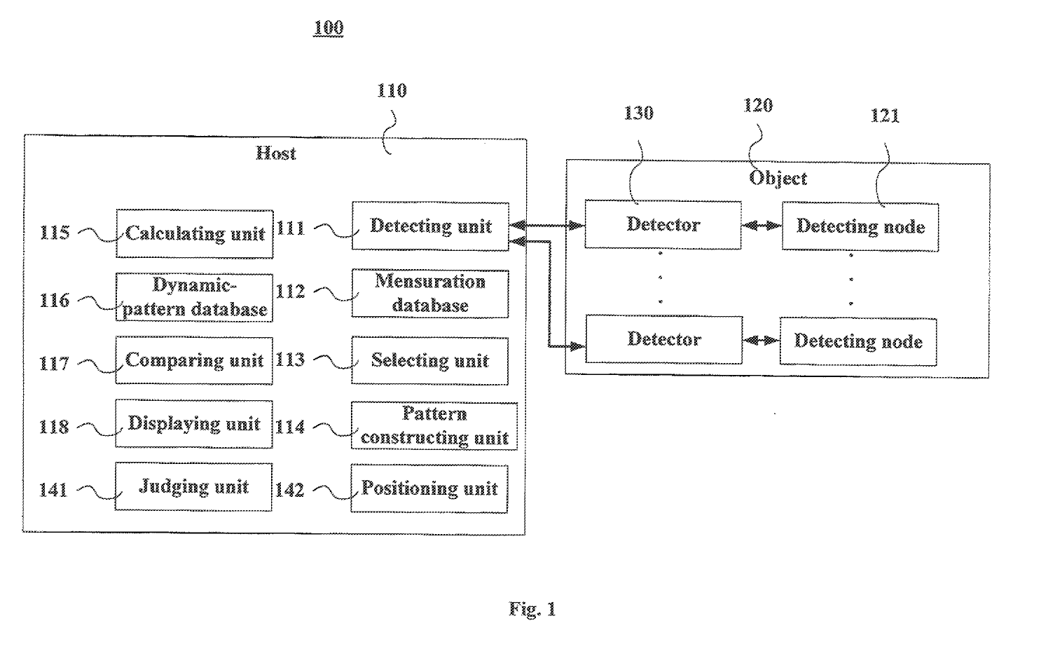

FIG. 1 is a block diagram of a movement-trace sensing system according to a preferred embodiment of the present invention.

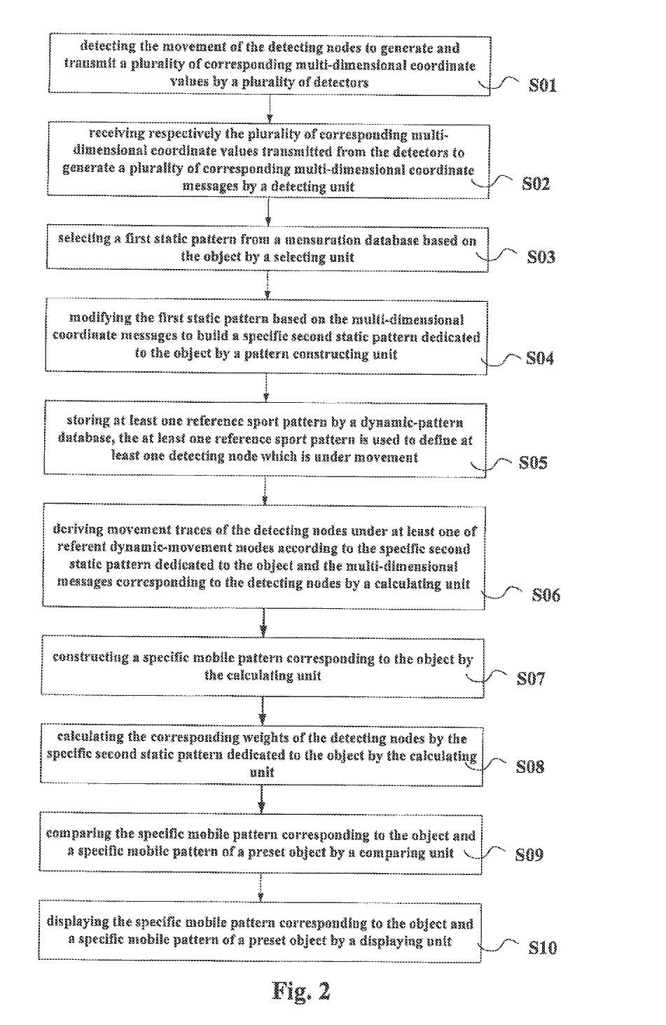

FIG. 2 is a flow diagram of a mobile pattern constructing method for a movement-trace sensing system 100 of a preferred embodiment of the present invention. The movement-trace sensing system 100 is applied on an object 120 under detection with a plurality of sensing points 121 (1st sensing node to nth sensing node). The movement-trace sensing system 100 comprises a plurality of sensors 130 (1st sensor to nth sensor) and a host 110. The plurality of sensors 130 are used to respectively sense the movement of the sensing points 121 to generate a plurality of corresponding multi-dimensional coordinate values (3D coordinate values). In practice, the sensors 130 could be disposed on the sensors 121 by adhesives, by wearing, or by embedded, etc.; moreover, the host 110 could be disposed on the object 120 by wearing.

The host 110 comprises a sensing unit 111, a mensuration database 112, a selecting unit 113, a pattern constructing unit 114, a calculating unit 115, a dynamic-pattern database 116, a comparing unit 117, and a displaying unit 118.

The sensing unit 111 is used to respectively receive the plurality of corresponding multi-dimensional coordinate values transmitted from the plurality of sensors 130 to generate a plurality of corresponding multi-dimensional coordinate messages. The multi-dimensional coordinate messages comprise the information of the stereoscopic xyz coordinates and the spin angles of the sensors along with time,

The selecting unit 113 is used to select a first static pattern from the mensuration database 112 based on the object. The mensuration database 112 comprises basic patterns of human or animals. Take a human for example, an Asian person, a European person, and other people have basic differences, such as an Asian person is smaller with thinner limbs. For example, assuming the object 120 is human, when the user enters species, region, nationality, gender, age, height, and weight, with the multi-dimensional coordinate messages, the pattern constructing unit 114 modifies the first static pattern to build a specific second static pattern dedicated to the object.

The dynamic-pattern database 116 is used to store at least one reference sport pattern. For example, swimming and running require different sensors 130 to be sensed, with selecting a right mobile pattern, the calculation is speed increased and a more accurate result is obtained. The at least one reference sport pattern is used to define at least one sensing node 121 which is under movement. The main sensing points 121 which affect the sport are not completely the same in different mobile patterns. For example, the shaking of the arms is much important to some sports, the waving of the waist is much important to some sports; hence, sensing different sensing points 121 according to different mobile patterns could make the calculation result better.

The calculating unit 115 derives movement traces of the sensing points 121 under at least one of referent dynamic-movement modes according to the specific second static pattern dedicated to the object 120 and the multi-dimensional messages corresponding to the sensing points, and further generates a specific mobile pattern corresponding to the object 120, and calculates the corresponding weights of the sensing points 121 by the specific second static pattern dedicated to the object, and calculates speed, acceleration, and forces of the sensing points 121 under the at least one of referent dynamic-movement modes based on the movement traces of the sensing points and the corresponding weights of the sensing points 121.

The comparing unit 117 compares the specific mobile pattern corresponding to the object 120 and a specific mobile pattern of a preset object. Continuing with the previous example, when the user wants to sense whether his exercise posture has room for improvement or not, it is possible by comparing his exercise posture and a professional athlete's exercise posture. So the preset object could be a professional athlete. By comparing the specific mobile pattern corresponding to him and a specific mobile pattern of the professional athlete, his exercise posture could be corrected effectively. In the mean time, a deviation between the movement-trace of the sensing points 121 and the movement-trace of the professional athlete are generated.

The display unit 118 displays the specific mobile pattern corresponding to the object 120 and a specific mobile pattern of a preset object. After the comparison of the movement-trace of the sensing points 121 and the movement-trace of the professional athlete are generated is processed by the comparing unit 117, and displayed at the same time by the display unit 118, the user can easily find out the differences.

The movement-trace sensing system 100 further comprises a judging unit 141, The judging unit 141 is used to determine whether the deviation derived by the comparing unit 117 is larger than a preset value, the preset value could be a specific value or a range which is set up by the user in advance. If the deviation is larger than the preset value, the judging unit 141 will determine that the present movement-trace of the at least one sensing points 121 is wrong, and issue an error signal. The user can immediately correct the present movement-trace of the sensing points 121 (such as the angle of rotation or the moving distance) according to the issued error signal.

More specifically, the plurality of sensors 130 and the host 110 are disposed at a specific positions before starting the movement-trace sensing system 100, then the host 110 is started and numerical information of absolute position of the host is derived by a positioning unit of the host 110; numerical information comprises data such as absolute coordinate values and height information. In a specific position, the absolute distances between each of the sensors 130 and the host 110 are known, the positioning unit 142 could derive initial relative coordinate values between each sensors 130 and the host 110. Also, the initial absolute coordinate values of each sensors 130 arc derived according to the information of the absolute position of the host 110 and the initial relative coordinate values between each of the sensors 130 and the host 110. Then the plurality of sensors 130 are activated and disposed on each of the sensing points 121 of the object 120 to collect the multi-dimensional coordinate values. The sensing unit 111 is used to generate the plurality of corresponding multi-dimensional coordinate messages according to the initial relative coordinate values of the sensors 130 and the collected multi-dimensional coordinate values. It should be noted that the positioning unit 142 could be an indoor positioning system, and the movement-trace sensing system of the present invention will not be limited by exercise position of the object 120.

Preferably, the mensuration database 112, the selecting unit 113, the calculating unit 115, the dynamic-pattern database 116, the comparing unit 117, and the judging unit 141 of the host 110 could be disposed in another electronic device to lower the workload of the host 110, and the electronic device could be connected with a cloud platform for more applications.

FIG. 2 is a flow diagram of a mobile pattern constructing method for a movement-trace sensing system 100 according to a preferred embodiment of the present invention, The units used in the method are referred to FIG. 1. First, the information of the object 120 is entered. For example, when the object 120 is human, as much. detailed information as possible such as species, region, nationality, gender, age, height, and weight need to be entered. During the movement of the object 120, the plurality of sensors 130 keep recording the plurality of coordinated messages of the plurality of sensing points 121.

First, step S01, sensing the movement of the sensing points 121 to generate and transmit a plurality of corresponding multi-dimensional coordinate values by a plurality of sensors 130.

Then, step S02, receiving respectively the plurality of corresponding multi-dimensional coordinate values transmitted from the sensors 130 to generate a plurality of corresponding multi-dimensional coordinate messages by a sensing unit 111.

Then, step S03, selecting a first static pattern from a mensuration database 112 based on the object 120 by a selecting unit 113. With more of the information about the object 120, the first static pattern corresponding to the object 120 is better fit to a real state of the object 120. The difference between the present invention and the traditional image capturing technology is that all of the physical parameters (speed, acceleration, angular speeds, and angular acceleration) relative to the sensors 130 could be quickly calculated according to the plurality of multi-dimensional messages.

Then, step S04, modifying the first static pattern based on the multi-dimensional coordinate messages to build a specific second static pattern dedicated to the object 120 by a pattern constructing unit 114. Since the first static pattern is a constructed by a mean value, the specific second static pattern dedicated to the object 120 is generated by the modification according to the plurality of multi-dimensional messages.

Then, step S05, storing at least one reference sport pattern by a dynamic-pattern database 116, the at least one reference sport pattern is used to define at least one sensing node 121 which is under movement.

Then, step S06, deriving movement traces of the sensing points 121 under at least one of referent dynamic-movement modes according to the specific second static pattern dedicated to the object 120 and the multi-dimensional messages corresponding to the sensing points 121 by a calculating unit 115.

Then, Step S07, constructing a specific mobile pattern corresponding to the object 120 by the calculating unit 115.

Then, step S08, calculating the corresponding weights of the sensing points 121 by the specific second static pattern dedicated to the object 120 by the calculating unit 115. For example, for two humans with the same height and weight, the lengths and weight of their arms might be different, So the corresponding weights of the plurality of sensing points 121 of the object 120 are derived after calculation,

Then, step S09, comparing the specific mobile pattern corresponding to the object 120 and a specific mobile pattern of a preset object by a comparing unit 117.

Then, step S10, displaying the specific mobile pattern corresponding to the object 120 and a specific mobile pattern of a preset object by a displaying unit 118.

Although the present invention has been disclosed as preferred embodiments, the foregoing preferred embodiments are not intended to limit the present invention. Those of ordinary skill in the art, without departing from the spirit and scope of the present invention, can make various kinds of modifications and variations to the present invention. Therefore, the scope of the claims of the present invention must be defined.

What is claimed is:

1. A movement-trace sensing system, which is applied on an object under detection with a plurality of sensing points, comprising:
a plurality of sensors, being used to respectively sense the sensing points to generate and send a plurality of corresponding multi-dimensional coordinate values;
a host connected with the plurality of sensors, the host comprises a sensing unit, a mensuration database, a selecting unit, a pattern constructing unit, a calculating unit, and a dynamic-pattern database, the sensing unit being used to respectively receive the plurality of corresponding multi-dimensional coordinate values transmitted from the plurality of sensors to generate a plurality of corresponding multi-dimensional coordinate messages, the selecting unit being used to select a first static pattern from the mensuration database based on the object, the pattern constructing unit being used to modify the first static pattern based on the multi-dimensional coordinate messages to build a specific second static pattern dedicated to the object, the dynamic-pattern database being used to store at least one reference sport pattern, the at least one reference sport pattern being used to define at least one sensing node which is under movement, the calculating unit calculates movement-traces of the sensing points under at least one of referent dynamic-movement modes according to the specific second static pattern dedicated to the object and the multi-dimensional messages corresponding to the sensing points, and further generates a specific mobile pattern corresponding to the object.

2. The movement-trace sensing system according to claim 1, wherein the calculating unit further calculates corresponding weights of the sensing points by the specific second static pattern dedicated to the object.

3. The movement-trace sensing system according to claim 2, wherein the calculating unit calculates speed, acceleration, and forces of the sensing points under the at least one of referent dynamic-movement modes based on the movement traces of the sensing points and the corresponding weights of the sensing points.

4. The movement-trace sensing system according to claim wherein the host further comprises a comparing unit, which compares the specific mobile pattern corresponding to the object and a specific mobile pattern of a preset object.

5. The movement-trace sensing system according to claim 1, wherein the host further comprises a display unit, which displays the specific mobile pattern corresponding to the object and a specific mobile pattern of a preset object.

6. A movement-trace sensing system, which is applied on an object under detection with a plurality of sensing points, comprising:
a plurality of sensors, being used to respectively sense the movement of the sensing points to generate a plurality of corresponding multi-dimensional coordinate values;
a host, which comprises a sensing unit, a mensuration database, a selecting unit, a pattern constructing unit, a calculating unit, and a dynamic-pattern database,. the sensing unit being used to respectively receive the plurality of corresponding multi-dimensional coordinate values transmitted from the plurality of sensors to generate a plurality of corresponding multi-dimensional coordinate messages, the selecting unit being used to select a first static pattern from the mensuration database based on the object, the pattern constructing unit being used to modify the first static pattern based on the multi-dimensional coordinate messages to build a specific second static pattern dedicated to the object, the dynamic-pattern database being used to store at least one reference sport pattern, the at least one reference sport pattern being used to define at least one sensing node which is under movement, the calculating unit derives movement-traces of the sensing points under at least one of referent dynamic-movement modes according to the specific second static pattern dedicated to the object and the multi-dimensional messages corresponding to the sensing points, and further generates a specific mobile pattern corresponding to the object.

7. The movement-trace sensing system according to claim 6, wherein the calculating unit further calculates corresponding weights of the sensing points by the specific second static pattern dedicated to the object.

8. The movement-trace sensing system according to claim 7, wherein the calculating unit calculates speed, acceleration, and forces of the sensing points under the at least one of referent dynamic-movement modes based on the movement traces of the sensing points and the corresponding weights of the sensing points.

9. The movement-trace sensing system according to claim 6, wherein the host further comprises a comparing unit, which compares the specific mobile pattern corresponding to the object and a specific mobile pattern of a preset object.

10. The movement-trace sensing system according to claim 6, wherein the host further comprises a display unit, which displays the specific mobile pattern, corresponding to the object and a specific mobile pattern of a preset object.

11. A motion model constructing method, which is applied on an object under detection with a plurality of sensing points, comprising:
sensing the movement of the sensing points to generate and transmit a plurality of corresponding multi-dimensional coordinate values by a plurality of sensors;
receiving respectively the plurality of corresponding multi-dimensional coordinate values transmitted from the sensors to generate a plurality of corresponding multi-dimensional coordinate messages by a sensing unit;
selecting a first static pattern from a mensuration database based on the object by a selecting unit;
modifying the first static pattern based on the multi-dimensional coordinate messages to build a specific second static pattern dedicated to the object by a pattern constructing unit;
storing at least one reference sport pattern by a dynamic-pattern database, the at least one reference sport pattern being used to define at least one sensing node which is under movement;
deriving movement traces of the sensing points under at least one of referent dynamic-movement modes according to the specific second static pattern dedicated to the object and the multi-dimensional messages corresponding to the sensing points the calculating unit by a calculating unit; and
constructing a specific mobile pattern corresponding to the object.

12. The method according to claim 11, further comprising:
calculating corresponding weights of the sensing points by the specific second static pattern dedicated to the object by the calculating unit.

13. The method according to claim 12, further comprising:
calculating speed, acceleration, and forces of the sensing points under the at least one of referent dynamic-movement modes based on the movement traces of the sensing points and the corresponding weights of the sensing points by the calculating unit.

14. The method according to claim 11, further comprising:
comparing the specific mobile pattern corresponding to the object and a specific mobile pattern of a preset object by a comparing unit.

15. The method according to claim 11, further comprising:
displaying the specific mobile pattern corresponding to the object and a specific mobile pattern of a preset object by a displaying unit.
